(19) United States
(12) Patent Application Publication
(10) Pub. No.: US 2017/0054517 A1
(43) Pub. Date: Feb. 23, 2017

(54) ARCHITECTURE FOR ENABLING HYPOTHESIS, ODYSSEY, AND YIELD WIRELESS AUTOMATED TEST EQUIPMENT TESTING

(71) Applicant: QUALCOMM Incorporated, San Diego, CA (US)

(72) Inventors: Karthikeyan Subramanian, Bangalore (IN); Sanjay Muchini, Bangalore (IN); Kasi Viswanadh Chunduri, Bangalore (IN); Sneha Revankar, Bangalore (IN)

(21) Appl. No.: 14/827,590

(22) Filed: Aug. 17, 2015

(51) Int. Cl. H04B 17/15; H04B 17/29

(52) U.S. Cl. CPC H04B 17/15; H04B 17/29

(57) ABSTRACT

A method and apparatus for wirelessly testing an electronic device. The method begins when the test instructions are retrieved from a data execution unit that is part of a test wrapper circuit. The test wrapper circuit then relays to at least one electronic component to be tested. The testing is then performed in accordance with the received test instructions, which may include built-in self-tests, functional tests, logic tests, and other tests based on the performance characteristics of the device being tested. The test responses are collected and sent back to the data execution unit. The test wrapper circuit provides the functional blocks to facilitate wireless testing of the electronic device. These functional blocks include an instruction retrieving unit, a data retrieving unit, a response buffer, and a data execution unit that facilitates communication.

### FIELD

The present disclosure relates generally to wireless communication systems, and more particularly to a method and apparatus for wireless testing of electronic devices, including wireless communication system-on-chip (SoC) devices.

### BACKGROUND

Wireless communication devices have become smaller and more powerful as well as more capable. Increasingly users rely on wireless communication devices for mobile phone use as well as email and Internet access. At the same time, devices have become smaller in size. Devices such as cellular telephones, personal digital assistants (PDAs), laptop computers, and other similar devices provide reliable service with expanded coverage areas. Such devices may be referred to as mobile stations, stations, access terminals, user terminals, subscriber units, user equipments, and similar terms.

A wireless communication system may support communication for multiple wireless communication devices at the same time. In use, a wireless communication device may communicate with one or more base stations by transmissions on the uplink and downlink. Base stations may be referred to as access points, Node Bs, or other similar terms. The uplink or reverse link refers to the communication link from the wireless communication device to the base station, while the downlink or forward link refers to the communication from the base station to the wireless communication devices.

Wireless communication systems may be multiple access systems capable of supporting communication with multiple users by sharing the available system resources, such as bandwidth and transmit power. Examples of such multiple access systems include code division multiple access (CDMA) systems, time division multiple access (TDMA) systems, frequency division multiple access (FDMA) systems, wideband code division multiple access (WCDMA) systems, global system for mobile (GSM) communication systems, enhanced data rates for GSM evolution (EDGE) systems, and orthogonal frequency division multiple access (OFDMA) systems.

Wireless communication systems have benefitted from the rapid advancement of deep sub-micron process technology. This technology has provided better performance with lower power, lower cost, while at the same time providing higher density and higher capacity. These developments facilitated the development of system-on-chip wireless technology, with a complete system on a single silicon chip. While the development of sub-micron technology has made more powerful devices with a smaller footprint, this has come at the price of increasingly complex and costly test procedures to ensure that SoCs and similar devices meet the required performance specifications.

There is a need in the art for wireless test access to SoCs and similar devices to provide better test performance, greater efficiency, and lower test cost.

### SUMMARY

Embodiments described herein provide a method for wirelessly testing an electronic device. The method begins when the test instructions are retrieved from a data execution unit that is part of a test wrapper circuit. These instructions are then relayed to at least one electronic component to be tested. The testing is then performed in accordance with the received test instructions, which may include built-in self-tests, functional tests, logic tests, and other tests based on the performance characteristics of the device being tested. The test response are collected and then sent back to the data execution unit. The test wrapper circuit provides the functional blocks to facilitate wireless testing of the electronic device.

A further embodiment provides an apparatus for wirelessly testing an electronic device having multiple cores, including a signal processing core. A modem core is in communication with the signal processing core. In addition, a test core performs the received test instructions. The wireless testing is facilitated using a test wrapper circuit. The test wrapper circuit includes: an instruction receiving unit, a data retrieving unit, a response buffer unit, and a data execution unit. The data execution unit relays instructions and responses to and from the units. Communication is provided by means of a communication bus interface connected to the data execution unit of the test wrapper circuit.

A still further embodiment provides an apparatus for wirelessly testing an electronic device. The apparatus provides: means for retrieving test instructions from a data execution unit; means for relaying the test instructions to at least one electronic component to be tested; means for performing the test instructions on the at least one electronic component to be tested; means for collecting the test responses; and means for sending the test responses to the data execution unit.

### BRIEF DESCRIPTION OF THE DRAWINGS

FIG. 1 illustrates a wireless multiple-access communication system, in accordance with certain embodiments of the disclosure.

FIG. 2 is a block diagram of a wireless communication system in accordance with embodiments of the disclosure.

FIG. 3 is a block diagram of a SoC incorporating a test wrapper circuit in accordance with embodiments of the disclosure.

FIG. 4 is a block diagram of the test wrapper circuit in accordance with embodiments of the disclosure.

FIG. 5 is a flowchart of a method of using a test wrapper circuit and embedded test features to wirelessly test an electronic device in accordance with embodiments of the disclosure.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, an integrated circuit, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network, such as the Internet, with other systems by way of the signal).

Furthermore, various aspects are described herein in connection with an access terminal and/or an access point. An access terminal may refer to a device providing voice and/or data connectivity to a user. An access wireless terminal may be connected to a computing device such as a laptop computer or desktop computer, or it may be a self-contained device such as a cellular telephone. An access terminal can also be called a system, a subscriber unit, a subscriber station, mobile station, mobile, remote station, remote terminal, a wireless access point, wireless terminal, user terminal, user agent, user device, or user equipment. A wireless terminal may be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. An access point, otherwise referred to as a base station or base station controller (BSC), may refer to a device in an access network that communicates over the air-interface, through one or more sectors, with wireless terminals. The access point may act as a router between the wireless terminal and the rest of the access network, which may include an Internet Protocol (IP) network, by converting received air-interface frames to IP packets. The access point also coordinates management of attributes for the air interface.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ), and integrated circuits such as read-only memories, programmable read-only memories, and electrically erasable programmable read-only memories.

Various aspects will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Other aspects, as well as features and advantages of various aspects, of the present invention will become apparent to those of skill in the art through consideration of the ensuring description, the accompanying drawings and the appended claims.

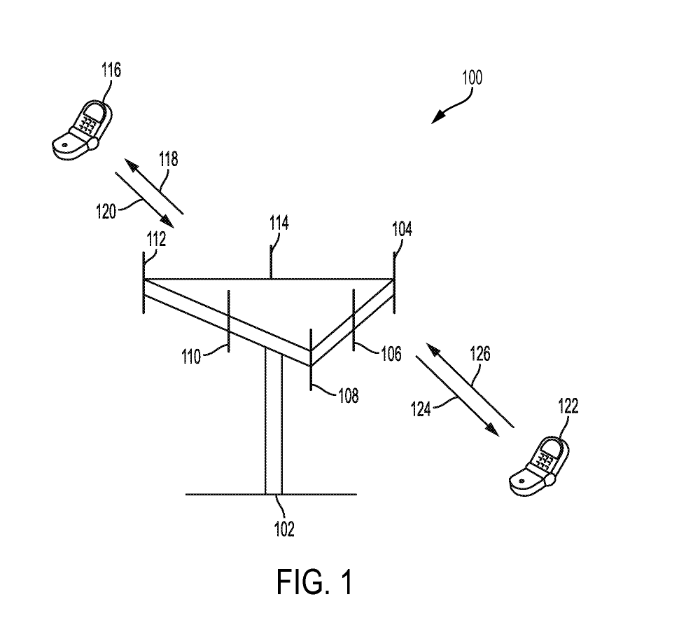

FIG. 1 illustrates a multiple access wireless communication system 100 according to one aspect. An access point 102 (AP) includes multiple antenna groups, one including 104 and 106, another including 108 and 110, and an additional one including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over downlink or forward link 118 and receive information from access terminal 116 over uplink or reverse link 120. Access terminal 122 is in communication with antennas 106 and 108, where antennas 106 and 108 transmit information to access terminal 122 over downlink or forward link 124, and receive information from access terminal 122 over uplink or reverse link 126. In a frequency division duplex (FDD) system, communication link 118, 120, 124, and 126 may use a different frequency for communication. For example, downlink or forward link 118 may use a different frequency than that used by uplink or reverse link 120.

Each group of antennas and/or the area in which they are designed to communicate is often referred to as a sector of the access point. In an aspect, antenna groups are each designed to communicate to access terminals in a sector of the areas covered by access point 102.

In communication over downlinks or forward links 118 and 124, the transmitting antennas of an access point utilize beamforming in order to improve the signal-to-noise ration (SNR) of downlinks or forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology. An access terminal may also be called a mobile station, user equipment (UE), a wireless communication device, terminal or some other terminology. For certain aspects, either the AP 102, or the access terminals 116, 122 may utilize the techniques described below to improve performance of the system.

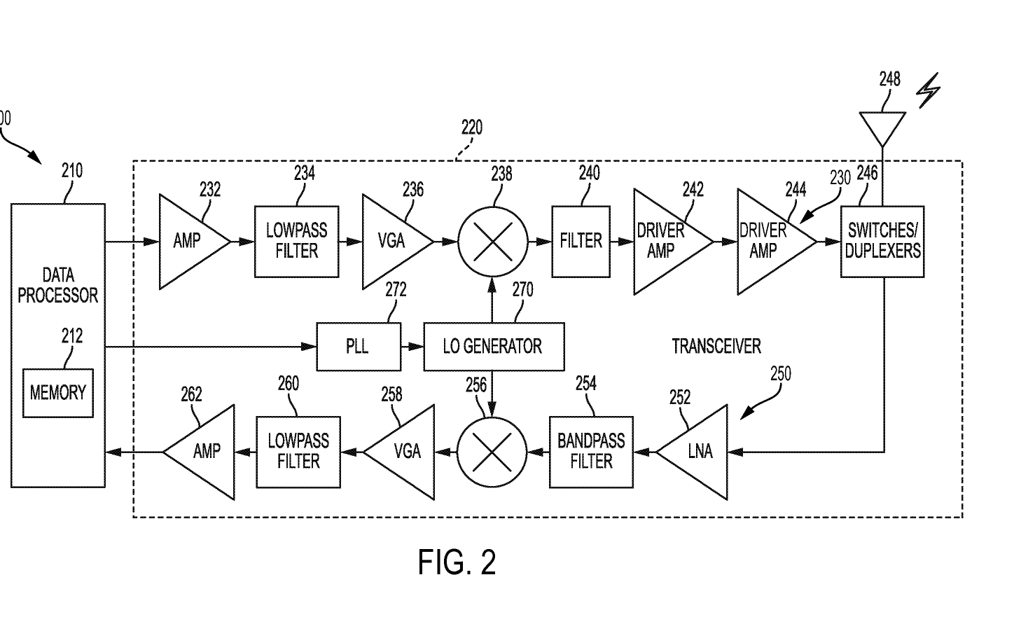

FIG. 2 shows a block diagram of an exemplary design of a wireless communication device 200. In this exemplary design, wireless device 200 includes a data processor 210 and a transceiver 220. Transceiver 220 includes a transmitter 230 and a receiver 250 that support bi-directional wireless communication. In general, wireless device 200 may include any number of transmitters and any number of receivers for any number of communication systems and any number of frequency bands.

In the transmit path, data processor 210 processes data to be transmitted and provides an analog output signal to transmitter 230. Within transmitter 230, the analog output signal is amplified by an amplifier (Amp) 232, filtered by a lowpass filter 234 to remove images caused by digital-to-analog conversion, amplified by a VGA 236, and upconverted from baseband to RF by a mixer 238. The upconverted signal is filtered by a filter 240, further amplified by a driver amplifier, 242 and a power amplifier 244, routed through switches/duplexers 246, and transmitted via an antenna 249.

In the receive path, antenna 248 receives signals from base stations and/or other transmitter stations and provides a received signal, which is routed through switches/duplexers 246 and provided to receiver 250. Within receiver 250, the received signal is amplified by an LNA 252, filtered by a bandpass filter 254, and downconverted from RF to baseband by a mixer 256. The downconverted signal is amplified by a VGA 258, filtered by a lowpass filter 260, and amplified by an amplifier 262 to obtain an analog input signal, which is provided to data processor 210.

FIG. 2 shows transmitter 230 and receiver 250 implementing a direct-conversion architecture, which frequency converts a signal between RF and baseband in one stage. Transmitter 230 and/or receiver 250 may also implement a super-heterodyne architecture, which frequency converts a signal between RF and baseband in multiple stages. A local oscillator (LO) generator 270 generates and provides transmit and receive LO signals to mixers 238 and 256, respectively. A phase locked loop (PLL) 272 receives control information from data processor 210 and provides control signals to LO generator 270 to generate the transmit and receive LO signals at the proper frequencies.

FIG. 2 shows an exemplary transceiver design. In general, the conditioning of the signals in transmitter 230 and receiver 250 may be performed by one or more stages of amplifier, filter, mixer, etc. These circuits may be arranged differently from the configuration shown in FIG. 2. Some circuits in FIG. 2 may also be omitted. All or a portion of transceiver 220 may be implemented on one or more analog integrated circuits (ICs), RF ICs (RFICs), mixed-signal ICs, etc. For example, amplifier 232 through power amplifier 244 in transmitter 230 may also be implemented on an RFIC. Driver amplifier 242 and power amplifier 244 may also be implemented on another IC external to the RFIC.

Data processor 210 may perform various functions for wireless device 200, e.g., processing for transmitter and received data. Memory 212 may store program codes and data for data processor 210. Data processor 210 may be implemented on one or more application specific integrated circuits (ASICs) and/or other ICs.

Before the wireless communication device described in FIGS. 1 and 2 may be used by a customer or end user, the SoC must be tested. This testing has required special test equipment and fixtures as well as test programs that exercise all of the functionality of the SoC or other device. Testing the transmit and receive functionality is a critical part of the test process. Embodiments described below provide a test host having a novel RF interface to wireless communication with a RF module within the device under test (DUT). This wireless testing is possible because the SoC has a modem system module and a RF module within SoC chip.

Testing SoCs has been aided by the development of automated test equipment (ATE). The ATE may incorporate a variety of test functionality, including: automated test pattern generator (ATPG), built-in self-test (BIST), and functional block test programs. Other test programs may also be used, depending on the performance characteristics of the device to be tested.

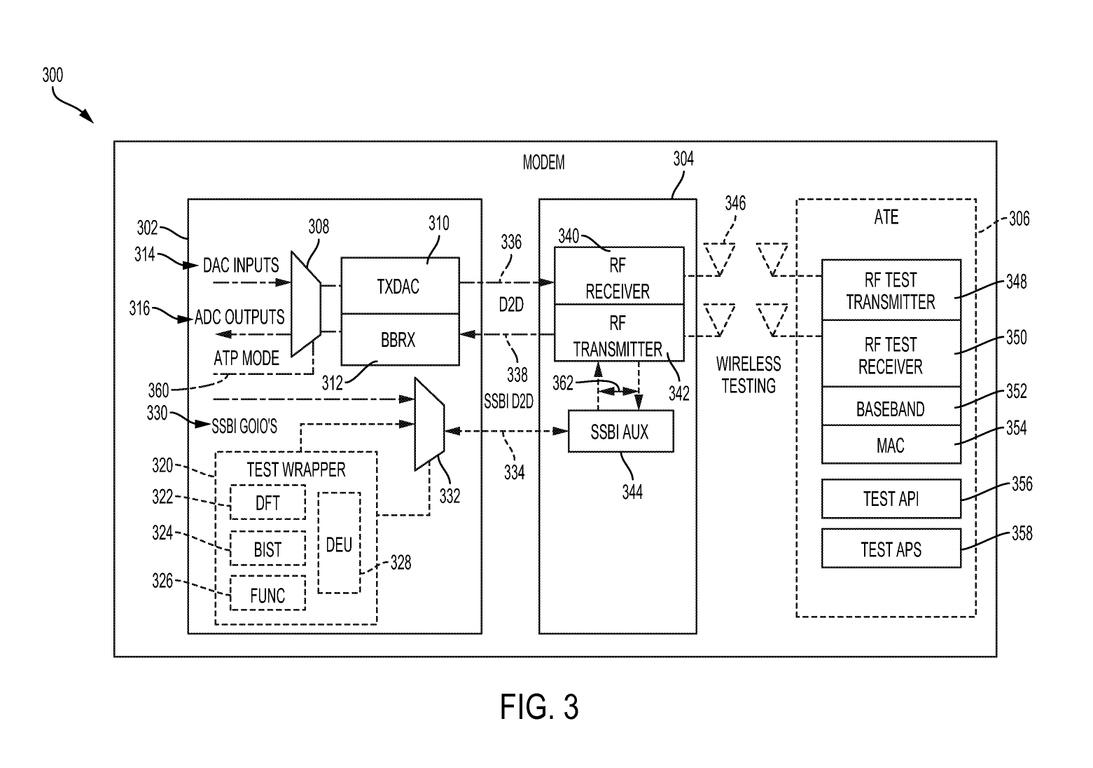

FIG. 3 is a block diagram of an electronic test assembly 300 incorporating a test wrapper circuit. The electronic test assembly 300 includes SoC chip module 302 as a subassembly of the electronic device assembly 300. Electronic device assembly 300 also includes modem subassembly 304, which in turn includes an RF receiver 340 and an RF transmitter 342. The electronic device assembly 300 further includes an automatic test equipment subassembly (ATE) 306. The ATE subassembly 306 may be located separately from SoC 302 and modem 304. SoC 302 and modem 304 may be located on the same die, or separate dies within a wireless device. The device to be tested may be tested while being shipped to a final assembly facility.

SoC module 302 includes a multiplexer 308 which receives input 314 from a digital to analog converter (DAC) 314 (not shown) and outputs analog to digital output (ADC) 316. Multiplexer 308 is in communication with transmit digital to audio converter (TXDAC) 310 and an additional output from multiplexer 308 is in communication with baseband receiver (BBRX) 312. Multiplexer 308 also has an input for automated test patterns 360 to be input. SoC module 302 also includes test wrapper 320. Test wrapper 320 incorporates design for test functions 322, built-in self-test (BIST) 324, function testing 326 and data exchange unit 328.

Test wrapper 320 provides single wire serial bus general purpose input/output (SSBI GPIO) to second multiplexer 332. Second multiplexer 332 also receives additional input over communication link 318. Second multiplexer 332 provides SSBI die-to-die (D2D) communication with modem 304 through communication link 334. Communication link 334 exchanges communication with SSBI auxiliary (SSBI AUX) device 344, located within modem 304. Further die-to-die signaling may be provided from TXDAC 310 to RF receiver 340 through communication link 336. Information may be provides to the BBRX from RF transmitter 342 through D2D communication link 338 RF transmitter 342 is also in communication with SSBI unit 344 and signals 342 may be sent to and from the RF transmitter 342 and the SSBI unit 344. In operation test wrapper 320 acts as a bridge between the device test circuits, which may include design for test circuits 322, BIST 324, functional test 326, and data exchange unit 328 through the SSBI interface 334.

Wireless testing is possible through antennas 346 connected with the RF receiver 340 and RF transmitter 342 located within modem 304. The wireless testing occurs when communications are sent from antennas 346 to ATE subassembly 306. ATE subassembly 306 includes RF test transmitter 348 and RF test receives 350. In addition, ATE subassembly 306 includes baseband module 342 which provides baseband signals. ATE 306 further includes medium access control subassembly (MAC) 354. Baseband module 342 and MAC 354 provide communication processing during wireless testing of SoC 302. ATE 306 also includes a test application processing interface 356 to allow a user to interface with the test functions. Application processing software 358 is also provided as part of ATE 302.

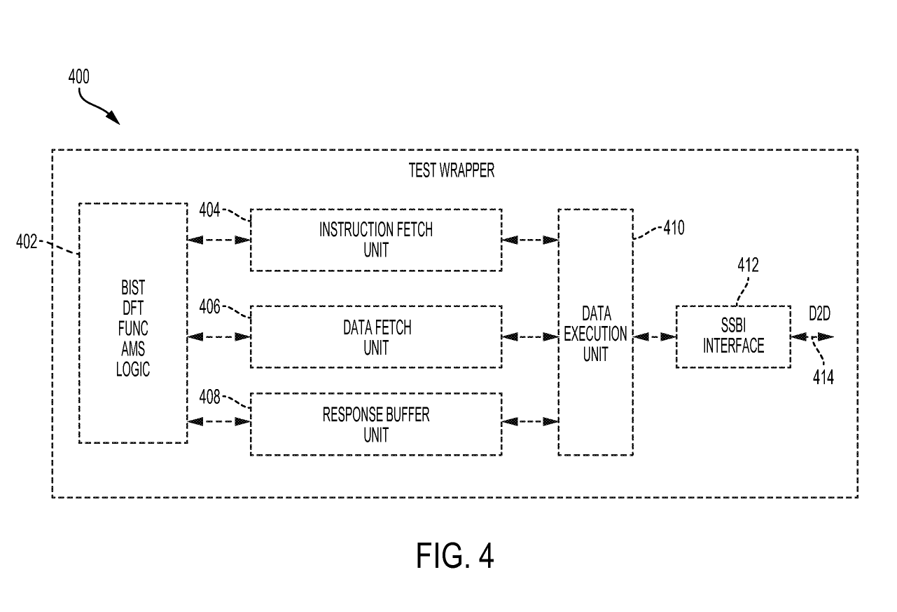

FIG. 4 is a block diagram of the test wrapper 400. Test wrapper assembly 400 includes testing functions 402. Testing functions 402 may include, but are not limited to the following: BIST, design-for-test, functional testing, and logic testing. Other test protocols may be added as needed during the design phase. Testing functions 402 communicate with instruction fetch unit 404, data fetch unit 406, and response buffer unit 408. Data exchange unit 410 communicates with instruction fetch unit 404, data fetch unit 406, and response buffer unit 408. The data exchange unit 410 is further in communication with SSBI interface 412. SSBI interface 412 communicates with modules and subassemblies outside of the test wrapper assembly 400 through die-to-die communication interface 414.

In operation the test wrapper assembly 400 fetches test instructions from the instruction buffer within the data exchange unit 410 and then executes the specified test operations on the devices under test in accordance with the fetched test instructions. The instruction fetch unit 404 retrieves instructions and an internal execution unit performs the retrieved test instructions. Once a test operation is complete, the execution unit within the instruction fetch unit 404 gathers the test responses and sends them to the response buffer of data execution unit 410. The results of the testing may be fed back to SSBI interface 412 for further communication over the die-to-die interface discussed above in FIG. 3.

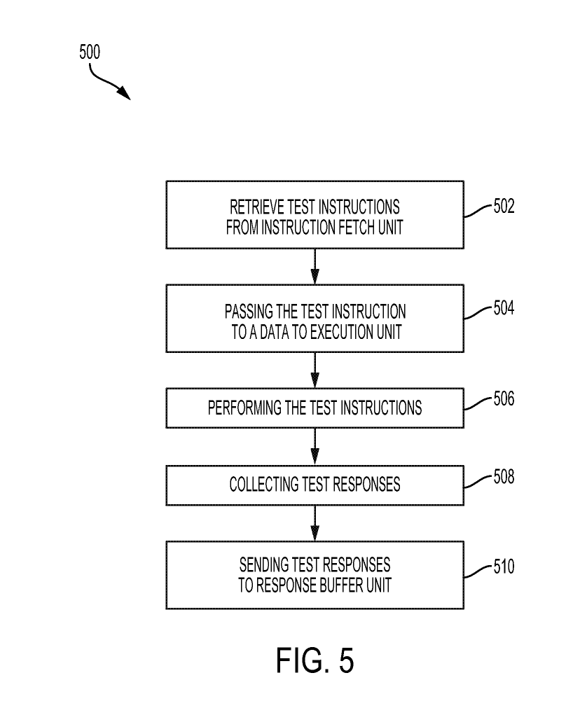

FIG. 5 is a flowchart of a method of using a test wrapper circuit and embedded test features to wirelessly test an electronic device. The method 500 begins when test instructions are retrieved from an instruction buffer 404. These test instructions are then passed in step 504 to a data execution unit 410. The test instructions may be sent by the data execution unit 410 through the SSBI interface 412 and D2D communication link 414 to the specific part of the SoC being tested. ATE 402 may specify the tests to be performed and may input this information to the instruction fetch unit 404 and the data fetch unit 406. These actions may be performed as part of step 504. In step 506 the designated tests are performed. Next, in step 508 the test response are collected and sent over the D2D 414 communication link to the SSBI 410 and then sent on to the data execution unit 410. The data execution unit then sends the test responses to the response buffer unit 408 in step 510. In an alternative embodiment the output of data execution unit 410 may be fed back to SSBI interface 412 to further communicate with the RF chip through D2D interface or link 414.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitter over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM EEPROM, CD-ROM or other optical disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A method of wirelessly testing an electronic device, comprising:
retrieving test instructions from a data execution unit;
relaying the test instructions to at least one electronic component to be tested;
performing the test instructions on the at least one electronic component to be tested;
collecting the test responses; and
sending the test responses to the data execution unit.

2. The method of claim 1, wherein relaying the test instructions uses a wireless interface.

3. The method of claim 1, wherein the test instructions are stored in a test wrapper circuit.

4. The method of claim 1, wherein a test wrapper circuit relays the test instructions to the at least one electronic component to be tested.

5. The method of claim 1, wherein the test instructions are retrieved from a test module on the electronic device.

6. The method of claim 5, wherein the test module contains multiple test instructions.

7. The method of claim 6, wherein the multiple test instructions include functional tests and logic tests.

8. An apparatus for wirelessly testing an electronic device, comprising:
an electronic device having multiple cores, including a signal processing core;
a modem core in communication with the signal processing core; and
a test core in communication with the modem core.

9. The apparatus of claim 8, wherein the test core communicates wirelessly with the signal processing core.

10. The apparatus of claim 9, wherein the signal processing core includes a test wrapper circuit.

11. The apparatus of claim 10, wherein the test wrapper circuit comprises:
an instruction retrieving unit in communication with the test core;
a data retrieving unit in communication with the test core;
a response buffer unit in communication with the test core;
a data execution unit in communication with the instruction retrieving unit, the data retrieving unit, and the response buffer unit; and
a communication bus interface connected to the data execution unit.

12. The apparatus of claim 11, further comprising:
a die-to-die communication interface in communication with the communication bus interface.

13. An apparatus for wirelessly testing an electronic device, comprising:
means for retrieving test instructions from a data execution unit;
means for relaying the test instructions to at least one electronic component to be tested;
means for performing the test instructions on the at least one electronic component to be tested;
means for collecting the test responses; and
means for sending the test responses to the data execution unit.

14. The apparatus of claim 13, further comprising:
means for wirelessly relaying the test instructions.

15. The apparatus of claim 13, wherein the means for relaying the test instructions incorporates a test wrapper.

16. The apparatus of claim 13, wherein the means for retrieving test instructions from a data execution unit includes means for retrieving instructions of multiple test function types.

17. The apparatus of claim 13 further comprising:
means for communicating with radio frequency devices external to the means for wirelessly testing an electronic device.

18. The apparatus of claim 17, wherein the means for communicating with radio frequency devices external to the means for wirelessly testing an electronic device further includes means for communicating with a radio frequency chip through a die-to-die interface.
